(19) United States
(12) Patent Application Publication
(10) Pub. No.: US 2009/0046024 A1
(43) Pub. Date: Feb. 19, 2009

(54) WIRELESS NETWORK CARD AND ANTENNA MODULE THEREOF

(75) Inventor: Gary HSU, Linkou Township (TW)

Correspondence Address: SUGHRUE MION, PLLC, 2100 PENNSYLVANIA AVENUE, N.W., SUITE 800, WASHINGTON, DC, 20037, US

(73) Assignee: BANDRICH INC., SINDIAN CITY (TW)

(21) Appl. No.: 12/036,689

(22) Filed: Feb. 25, 2008

(30) Foreign Application Priority Data
Aug. 16, 2007 (TW) 96213615

(51) Int. Cl. H01Q 1/24

(52) U.S. Cl. 343/702

(57) ABSTRACT

An antenna module of a wireless network card is disclosed. The antenna module includes a top case having a passage disposed on an side of the top case, a metal hinge having a hinge portion and a contact portion, an antenna coupled with the contact portion, and a bottom case mounted on the top case. The hinge portion is fixed in the passage, and the contact portion is extended from the hinge portion. The metal hinge and the antenna are contained between the top case and the bottom case. A wireless network card utilizing the antenna module is also disclosed.

### RELATED APPLICATIONS

This application claims priority to Taiwan Application Serial Number 96213615, filed Aug. 16, 2007, which is herein incorporated by reference.

### BACKGROUND

1. Field of Invention

The present invention relates to an antenna module. More particularly, the present invention relates to an antenna module of a wireless network card.

2. Description of Related Art

The development of the Internet and the popularization of personal computers enable data transmission from different places to be communicated. However, most of the current Internet infrastructures use wires made of different materials, such as optical fibers. Thus, using wireless network cards may create a convenient communications environment.

An antenna is an important device in the wireless network card. The quality of the antenna that receives signals greatly influences the quality of the wireless network card. Thus, there is a need to improve the signal reception abilities of the antenna in the wireless network card.

### SUMMARY

The invention provides an antenna module of a wireless network card. The antenna module includes a top case having a passage disposed on an side of the top case, a metal hinge having a hinge portion and a contact portion, an antenna coupled with the contact portion, and a bottom case mounted on the top case. The hinge portion is fixed in the passage, and the contact portion is extended from the hinge portion. The metal hinge and the antenna are contained between the top case and the bottom case.

The invention also provides a wireless network card utilizing the antenna module. The wireless network card includes a main body having a printed circuit board, and an antenna module hinged on the main body. The antenna module includes a top case having a passage disposed on an side of the top case, a metal hinge having a hinge portion and a contact portion, an antenna coupled with the contact portion, and a bottom case mounted on the top case. The hinge portion is fixed in the passage, and the contact portion is extended from the hinge portion. The metal hinge and the antenna are contained between the top case and the bottom case.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is an exploded diagram of an embodiment of an antenna module of a wireless network card of the invention; and

FIG. 2 is a partial exploded diagram of the wireless network card utilizing the antenna module of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

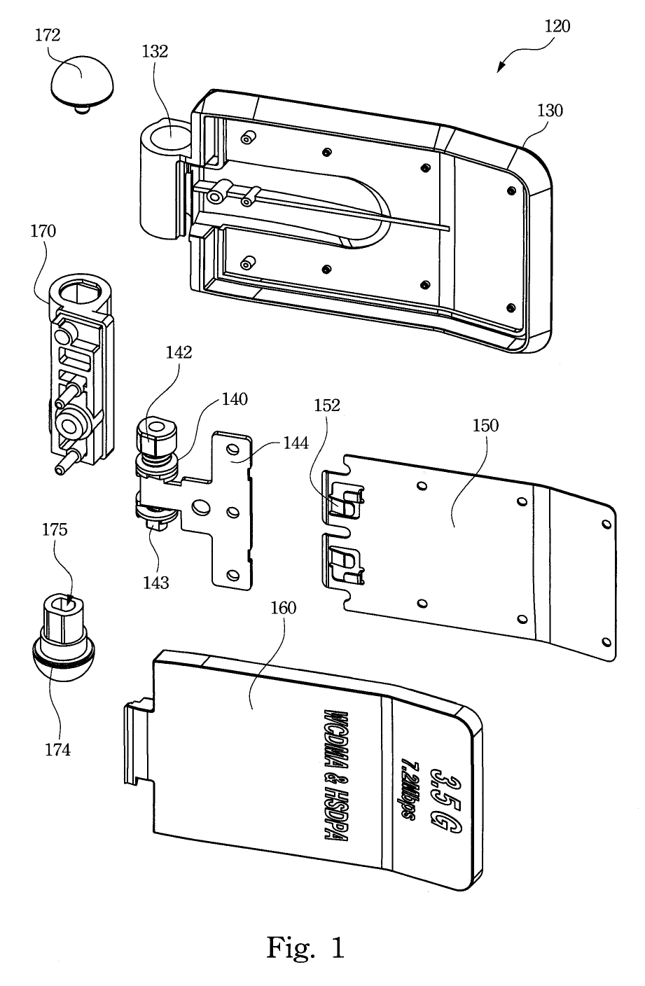

Refer to FIG. 1. FIG. 1 illustrates an exploded diagram of an antenna module of a wireless network card of the invention. The antenna module 120 includes a top case 130, a metal hinge 140, an antenna 150, a bottom case 160, and a shaping device 170. The top case 130 has a passage 132 disposed on a side of the top case 130. The metal hinge 140 has a hinge portion 142 and a contact portion 144. The hinge portion 140 is fixed in the passage 132. The contact portion 144 is extended from the hinge portion 142, and the antenna 150 is coupled with the contact portion 144 of the metal hinge 140. The top case 130 is mounted with the bottom case 160, and the antenna 150 is contained between the top case 130 and the bottom case 160. The shaping device 170 may wrap the passage 132 and the hinge portion 142 partially. The material of the top case 130, the bottom case 160, and the shaping device 170 may be a plastic.

An end of the hinge portion 142 may have a non-circle protrusion 143. The shaping device 170 may have two caps 172 and 174 disposed on two opposite sides of the shaping device 170. The cap 174 may have a non-circle cavity 175 corresponding to the non-circle protrusion 143. The non-circle protrusion 143 of the hinge portion 142 may couple with the non-circle cavity 175 of the cap 174 for increasing the strength of mechanical coupling when the antenna module 120 is pivoted.

The antenna 150 may have at least a hook 152. The hook 152 is disposed on a side near the metal hinge 140 of the antenna 150. The hook 152 may couple the antenna 150 to the contact portion 144 of the metal hinge 140. Thus, the metal hinge 140 may be regarded as a part extended from the antenna 150, and the receiving area and the receiving angle of the antenna module 120 may be enlarged, and the quality of the antenna module 120 would be highly improved.

The metal hinge 140 may be glued in the passage 132 of the top case 130. The metal hinge may also be ultrasonic welded for fixing in the passage 132. The top case 130 may also be ultrasonic welded or glued with the bottom case 160.

Different antennas have different preferred frequencies. The antenna 150 in this invention could be selected and changeable according to different countries, i.e. the antenna 150 has a preferred frequency according to the country where the wireless network card is used. Thus, the antenna module 120 could select the preferred antenna 150 for fitting different required frequencies for each country.

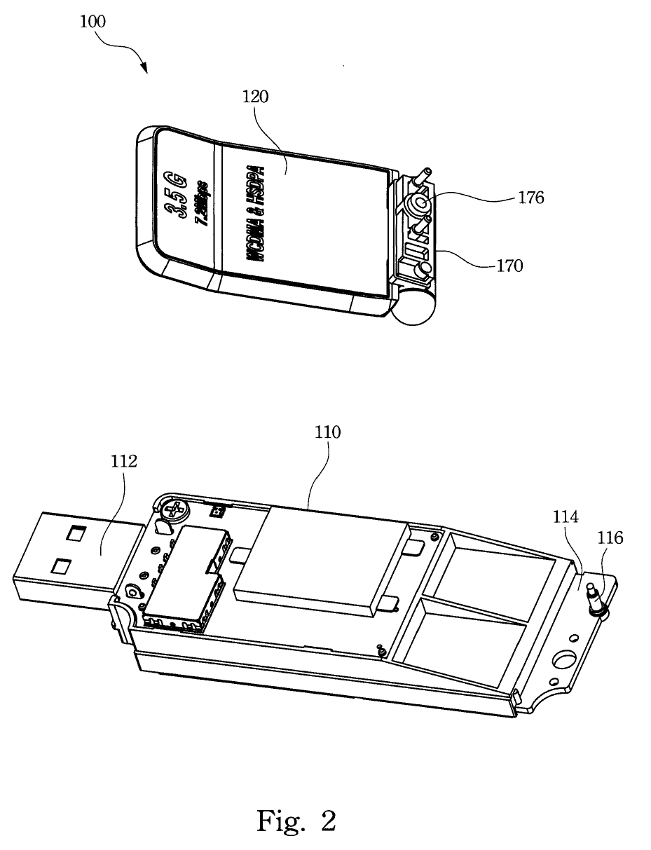

Refer to FIG. 1 and FIG. 2 simultaneously. FIG. 2 illustrates a partial exploded diagram of the wireless network card utilizing the antenna module of the invention. The wireless network card 100 includes a main body 110 and the antenna module 120 hinged on the main body 110. The main body 110 has a universal serial bus (USB) interface 112 and a printed circuit board 114. The main body 110 further includes a pogo pin 116 disposed on the printed circuit board 114. The shaping device 170 may have an opening 176, and the pogo pin 116 may pass through the opening 176 and touch the contact portion 144 of the metal hinge 140. The pogo pin 116 has a spring (not shown). The original length of the pogo pin 116 is slightly longer than the assembly distance between the printed circuit board 114 and the metal hinge 140. The pogo pin 116 may be compressed to touch the contact portion 144 of the metal hinge 140 firmly. The metal hinge 140 may be regarded as the part extended from the antenna 150, and the pogo pin 116 could connect the metal hinge 140 and the antenna 150 with the printed circuit board 114.

The metal hinge in this invention may be regarded as the extended part of the antenna, and the receiving area and the receiving angle of the antenna may be enlarged, and the receiving quality of the antenna module may be improved. The antenna module may fit different countries by selecting the preferred antenna with the preferred frequency according to the country, which the wireless network card is utilized in.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An antenna module of a wireless network card, the antenna module comprising:
a top case having a passage disposed on an side of the top case;
a metal hinge having a hinge portion and a contact portion, wherein the hinge portion is fixed in the passage, and the contact portion is extended from the hinge portion;
an antenna coupled with the contact portion; and
a bottom case mounted on the top case, wherein the metal hinge and the antenna are contained between the top case and the bottom case.

2. The antenna module of the wireless network card of claim 1, wherein the antenna has a preferred frequency, and the preferred frequency of the antenna is related to a country, which the wireless network card is utilized in.

3. The antenna module of the wireless network card of claim 1, further comprising a shaping device wrapping the passage and the hinge portion partially.

4. The antenna module of the wireless network card of claim 3, wherein an end of the hinge portion comprises a non-circle protrusion, the shaping device further comprises a cap having a non-circle cavity corresponding to the non-circle protrusion, and the cap couples with the non-circle protrusion of the hinge portion.

5. The antenna module of the wireless network card of claim 1, wherein the antenna comprises at least one hook disposed on a side near the metal hinge of the antenna for coupling the antenna with the contact portion of the metal hinge.

6. A wireless network card comprising:
a main body having a printed circuit board; and
an antenna module hinged on the main body, the antenna module comprising:
a top case having a passage disposed on an side of the top case,
a metal hinge having a hinge portion and a contact portion, wherein the hinge portion is fixed in the passage, and the contact portion is extended from the hinge portion,
an antenna coupled with the contact portion, and
a bottom case mounted on the top case, wherein the metal hinge and the antenna are contained between the top case and the bottom case.

7. The wireless network card of claim 6, wherein the antenna has a preferred frequency, and the preferred frequency of the antenna is related to a country, which the wireless network card is utilized in.

8. The wireless network card of claim 6, further comprising a shaping device wrapping the passage and the hinge portion partially.

9. The wireless network card of claim 8, wherein the shaping device comprises an opening; the printed circuit board comprises a pogo pin, and the pogo pin passes through the opening and contact with the contact portion of the metal hinge.

10. The wireless network card of claim 8, wherein an end of the hinge portion comprises a non-circle protrusion, the shaping device further comprises a cap having a non-circle cavity corresponding to the non-circle protrusion, and the cap couples with the non-circle protrusion of the hinge portion.

11. The wireless network card of claim 8, wherein the antenna comprises at least one hook disposed on a side near the metal hinge of the antenna for coupling the antenna with the contact portion of the metal hinge.
